(19) United States
(12) Patent Application Publication
(10) Pub. No.: US 2011/0025169 A1
(43) Pub. Date: Feb. 3, 2011

(54) PIEZOELECTRIC DRIVE UNIT

(75) Inventors: Walter Haussecker, Buehlertal (DE); Jorg Wallaschek, Paderborn (DE); Vincent Rieger, Karlsruhe (DE); Jens Twiefel, Paderborn (DE); Tobias Hemsel, Langenberg (DE); Volker Rischmueller, Leonberg (DE); Dirk Guenther, Jugenheim (DE); Peter Froehlich, Changsa (CN)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/599,245

(22) PCT Filed: Apr. 29, 2008
(86) PCT No.: PCT/EP2008/055245

§ 371 Date: Oct. 15, 2010

(30) Foreign Application Priority Data
May 7, 2007 (DE) 10 2007 021 337.0

(51) Int. Cl. H02N 2/04

(52) U.S. Cl. 310/323.16

(57) ABSTRACT

Disclosed are a piezoelectric drive unit (10) and a method for operating such a drive unit in order to adjust movable parts (11), especially in a motor vehicle. Said piezoelectric drive unit (10) comprises at least one piezo motor (12) that is fitted with at least one piezo actuator (18). At least one frictional element (30) of the piezo motor (12) makes it possible to generate a relative movement in relation to a frictional surface (14) located across from the frictional element (30). Said at least one frictional element (30) is disposed on a bridging web (28) of the motor (12). The bridging web (28) places the frictional element (30) at a distance (2) from the central axis (89) of the at least one piezo actuator (18), said central axis (89) extending in a longitudinal direction (19).

### STATE OF THE ART

The invention relates to a piezoelectric drive unit as well as a procedure for operating such a unit according to the category of the independent claims.

An ultra sound engine is known from WO 00/28652 A1, at which a rotor shaft is put into rotation with the aid of ultra sound vibrators. Two ultra sound vibrators are thereby connected with each other at right angles, whereby both vibrators are supplied with an alternating voltage in such a way that they vibrate with a phase difference to each other. This vibration generates a movement of a tappet, which puts the rotor shaft into rotation. Due to the arrangement of the tappet on the longitudinal axes of the piezo actuators only a relatively small impact can be generated. Therefore several ultra sound vibrators are required due to the configuration and operating mode of the vibrators in order to generate a sufficient drive torque. Such an engine is therefore very expensive and requires complex electronic controlling and a correspondingly big installation space.

### DISCLOSURE OF THE INVENTION

### Advantages of the Invention

In contrast to that the piezoelectric drive unit according to the invention, as well as the procedure for operating such a device with the characteristics of the independent claims provides the advantage that a leverage effect can be achieved by arranging the friction element on a bridging web, which increases the pushing movement of the friction element and generates thereby a bigger advance of the relative movement. By determining the distance of the friction element vertically to the longitudinal axis of the piezo actuator the amplification or the transmitted impact force can be adjusted, whereby an adjustment for different applications is possible.

With the measures that are stated in the dependent claims advantageous configurations and improvements of the implementations that are provided in the dependent claims are possible. If the bridging web is arranged basically vertically to the longitudinal direction of the piezo actuator the biggest amplification of the pushing movement is achieved. The bridging web can thereby be construed as free leverage arm on the one and hand or as connecting web to a second piezo actuator on the other hand. If the friction element is construed as extension in longitudinal direction the longitudinal vibration of the piezo actuator can be implemented into a pushing movement in longitudinal direction particularly effectively.

It is particularly advantageous if the friction element provides an impact surface, which abuts at the corresponding friction surface for the force transmission. The impact surface is thereby basically oriented parallel to the friction surface and basically vertically to the longitudinal direction of the piezo actuator, in order to maintain a high efficiency when transmitting the pushing movement onto the friction surface.

In a preferred embodiment of the invention there are exactly two piezo actuators that are arranged almost parallel to each other, whereby the bridging web between the two piezo actuators determines the distance across to the longitudinal direction. In this configuration the friction element can be put into a pushing or elliptical movement on the bridging web optionally by one of the two piezo actuators. The friction element is preferably construed as a tappet, which provides an expansion in longitudinal direction that is bigger than its expansion in transversal direction. If the friction element is attached centrally at the bridging web symmetric movements of the friction element can be achieved at an optional excitation of the first or the second piezo actuators, whereby the direction of the impact of the transversal component is construed opposite to each other. Thereby the relative movement can be realized with the same forces or advances in both directions.

Due to the arched construction of the impact surface the impact force can be transmitted optimally on the friction surface, in particular at an elliptical movement. Additionally the impact surface can be provided with an additional layer, which increases the friction to the friction surface.

It is particularly cost-efficient t manufacture the bridging web and the friction element as separate components, which can then be built together with the piezo actuators into the piezo motor. Alternatively the housing of the piezo actuators can be construed in one piece with the bridging web and/or the friction element, whereby corresponding mounting steps are omitted.

The housing of the piezo actuators can be construed as hollow body, in whose interior the piezo element can be inserted, which is particularly advantageous. The housing is thereby for example made of metal, which is electrically isolated from the piezo element.

In order to achieve a bigger mechanic amplitude of the piezo element, said is advantageously construed as multilayer ceramic or stack ceramic, so that the amplitudes of the individual layers add up to each other. These piezo ceramics are pre-stressed in longitudinal direction in the piezo housing in order to increase the efficiency of the piezo element and to avoid its destruction.

For pre-stressing the piezo elements screw elements are particularly suitable, which can be screwed into the actuator housing and/or in the bridging web.

The bridging web can be construed softer or more rigid depending on the desired functioning principle of the tappet movement. The rigidity of the bridging web can be influences by its material of form. For realizing a soft bridging web one or several areas can be for example formed with corresponding recesses, so that its material profile is reduced and/or made flexible.

For the electric contacting of the piezo elements a contact element can be arranged advantageously at the actuator housing, at which the electrodes of the piezo element can be connected with the electric control unit.

In order to achieve a bigger mechanic amplitude of the piezo element said is advantageously construed as multilayer ceramic or stack ceramic.

If the piezo ceramic is constructed of several layers, in between which electrodes are hooked up, a bigger vibration amplitude can be generated with a default voltage. If the layers are arranged transversally to the longitudinal direction of the piezo actuator, the longitudinal vibration in longitudinal direction is thereby maximized. The electrodes can therefore be advantageously arranged between the separated ceramic layers.

For creating a big vibration amplitude of the piezo actuator in longitudinal direction the piezo ceramic is pre-stressed in the piezo housing in such a way that no pulling forces occur in the piezo ceramic during vibration mode. Thereby a high-grade vibration system can be achieved, which provides a high rigidity in longitudinal direction.

Preferably the piezo actuator is only put into longitudinal vibrations, so that only vibration components along the longitudinal direction with the biggest expansion of the piezo actuator are excited. Therefore the piezo ceramic and the construction of the housing of the piezo actuator are correspondingly optimized.

The procedure according to the invention for operating piezoelectric drive units has the advantage, that the piezo motor or the entire drive unit can be excited in its resonance frequency with the aid of the tuning circuit of the electron unit. Due to the regulation on the zero crossing of the phase course of the drive system the resonance frequency can be complied with very accurately. By operating the piezo actuators in their resonance frequency their piezo ceramic is optimally used. Thereby a big deflection of the piezo actuator can be generated at relatively low material usage of the piezo ceramic, whereby a big advance or a big torque can be transmitted to the corresponding friction surface. Due to the resonance operation the piezo ceramic is operated in the point of its highest efficiency, whereby the electric power loss is reduced a lot so that a heating of the piezo ceramic is avoided. During resonance operation the piezo ceramic, the electronic unit and the voltage source are not burdened with idle power, whereby the electricity can be carried out more simply and additional switches and filter elements can be for example waived. By taking advantage of the dielectricity of the piezo ceramic no disturbing electro-magnetic fields are created, nor is the operation of the piezo ceramic notably affected by outside magnetic fields. When operating the piezo actuator in resonance operation the amplitude and the force transmission of the piezo actuator can be adjusted to the corresponding friction surface with the design of the piezo actuator. Due to the high power density of the piezo actuator the material usage of the relatively costly piezo ceramic can be reduced or the power of the piezo drive can be increased.

Due to the one-phased excitation of the piezo motor a second electronic unit/tuning circuit per piezo motor can be waived. Only a single excitation signal has to be generated. That simplifies the signal processing and the coordination of different piezo motors. By controlling only one piezo actuators of a piezo motor its control electronic is significantly simplified. The vibration behavior of the piezo motor is only determined by the single excitation frequency, so that the moving track of the tappet can be easily pre-determined. At outer influences, which alienate the resonance frequency, the resonance frequency can be significantly easier tracked with a one-phased excitation. If the longitudinal direction of the piezo actuator in idle mode is basically oriented vertically to the corresponding friction surface of the drive element the longitudinal vibration of a single piezo actuator can be effectively put one or the other moving direction of the relative movement opposite the friction surface.

Due to the micro-stroke movement of the friction element opposite of the corresponding friction surface a relative movement can be generated without having to put additional inertial masses into motion. By a suitable selection of the friction partner between the friction element and the corresponding friction surface the vibration of the piezo actuator can be put into a linear movement or a rotational movement of a drive element with a low-loss. For supporting the force transmission a form fit between the friction element and the friction surface can be construed in addition to the friction fit. The drive element with the friction surface can advantageously be construed as linear drive rail or rotor shaft. Due to the holding force, with which the friction element is pressed against the linear rail or the rotation body, the tangential movement component of the friction element is transmitted to the drive element. It is particularly advantageous to attach the piezo motor at the movable part so that it moves away with the movable part from a stationary friction surface. The piezo motor can for example be attached to a window pane and push itself along a friction surface of a car-body-rigid guide rail. Due to the direct creation of a linear movement a very fast response time with a high dynamic is enabled. Due to the micro-stroke principle a particularly precise positioning of the part that has to be adjusted can be achieved at a low noise emission.

### DRAWINGS

Embodiments of the invention are illustrated in the drawings and further explained in the following description. It is shown in:

FIG. 1 a piezoelectric drive unit according to the invention,

FIG. 2 a further configuration for a rotational drive,

FIG. 3 a piezo element for the into the piezo actuator according to FIG. 1,

FIG. 4 a schematic illustration for operating the drive unit,

FIG. 5 a resonance curve of the piezo motor,

FIG. 6 an impedance curve for the piezoelectric drive system,

FIG. 7 a further embodiment of a drive unit with an integrated load sensor,

FIG. 8a, b explosion views of two piezo motors according to the invention,

FIG. 9a, b the schematic creation of different vibration forms, and

FIG. 10a, b the force transmission of the tappet movement.

### EMBODIMENTS OF THE INVENTION

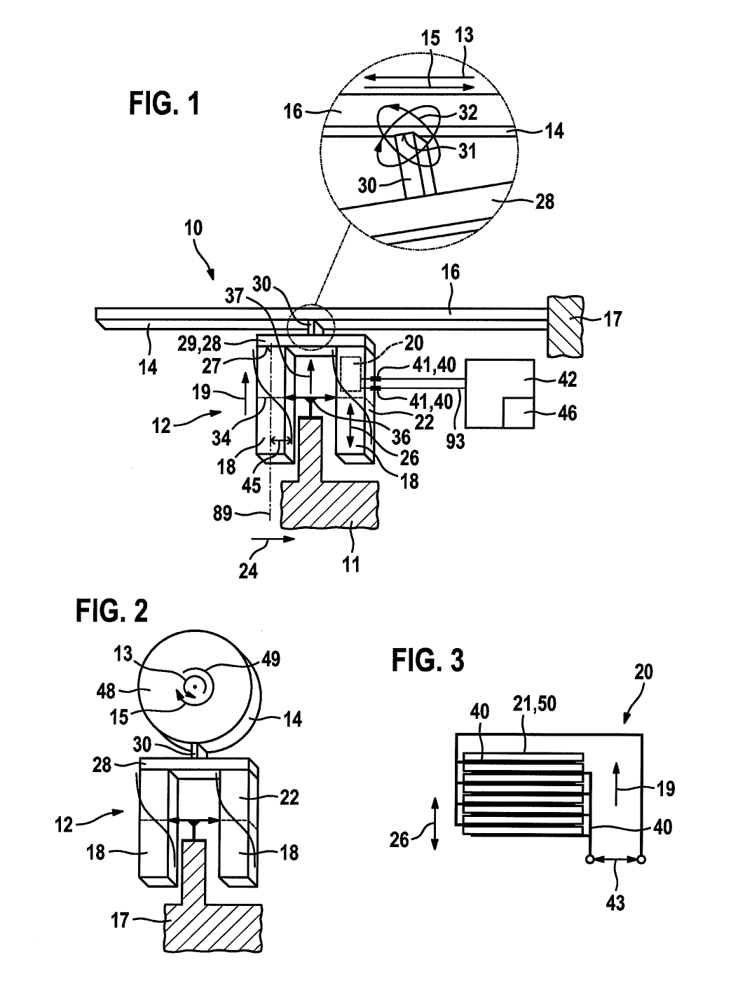

FIG. 1 shows a piezoelectric drive unit 10, at which a piezo motor 12 carries out a relative movement towards a corresponding friction surface 14. The friction surface 14 is thereby construed as linear rail 16, which is attached for example to a body panel 17. The piezo motor 12 provides at least one piezo actuator 18, which on the other hand contains a piezo element 20. The piezo actuator 18 provides therefore an actuator housing 22, which accommodates the piezo element 20. The actuator housing 22 is for example construed in the shape of a capsule. The piezo element 20 is embraces by the actuator housing 22 in the illustrated embodiments. The piezo actuator 18 provides a longitudinal direction 19, in whose direction the expansions of the piezo actuator 18 are bigger than in a transversal direction 24 to it. The piezo element 20 is preferably pre-stressed in the actuator housing 22 in longitudinal direction 19 in such a way that no pulling forces occur in the piezo element 20 when exciting a longitudinal vibration 26 of the piezo element 20. Due to the vibration of the piezo element 20 the entire piezo actuator 18 is put into longitudinal vibration 26 and transmits a vibration amplitude 45 over a bridging web 28 to a friction element 30, which is in frictional contact with the friction surface 14. Due to the longitudinal vibration 26 of the piezo actuator 18 the bridging web 28 is put into a tilting movement or a bending movement, so that an end 31 of the friction element 30 that is facing the friction surface 14 carries out a micro-stroke movement. The interaction between the friction element 30 and the friction surface 14 is shown in the enlarged section, in which it can be seen that the bridging web 28, which is arranged almost parallel to the friction surface 14 in idle position, tilts towards the friction surface 14 at an excited vibration of the piezo actuator 18. The end 31 of the friction element 30 performs thereby for example approximately an elliptical movement 32 or a circular movement, due to which the piezo motor 12 pushes itself along the linear rail 16. The piezo motor 12 is stored in the area of vibration nodes 34 of the piezo actuators 18 and for example connected with part 11 that has to be moved. Simultaneously the piezo motor 12 is pressed against the friction surface 14 by a bearing 36 with a normal force 37. Thereby the end 31 of the friction element 30 performs now an elliptical movement 32, which provides in addition to the normal force 37 also a tangential force component 36, which causes the advance of the piezo motor 12 towards the friction surface 14. In an alternative embodiment the friction element 30 only performs a linear pushing movement under a certain angle to the normal force 37. This also results in a relative movement by means of micro-strokes.

In the embodiment according to FIG. 1 the piezo motor 12 provides exactly two piezo actuators 18, which are both arranged almost parallel to their longitudinal direction 19. The bridging web 28 is thereby arranged transversally to the longitudinal direction 19 and connects the two piezo actuators 18 at their front sides 27. The bridging web 28 is for example construed as flat plate 29, in whose center the friction element 30 is arranged. In a preferred operating mode of the piezoelectric drive unit 10 only one of the two piezo actuators 18 is excited for a relative movement in a first direction 13. The second not excited piezo actuator 18 works thereby over the bridging web 28 as vibration mass, due to which the bridging web 28 is tilted or bended with the friction element 30 towards the longitudinal direction 19. According to the rigidness of the construction of the piezo motor 12 the longitudinal vibration 26 of the piezo element 20 is therefore converted into a micro-stroke movement with a tangential force component 38. The electric excitation of the piezo element 20 takes place over electrodes 40, which are connected with an electronic unit 42 by a contact element 41. For a movement of the piezo motor 12 in the opposite directions 15 the piezo element 20 of the other piezo actuator 18 is corresponding excited with the aid of the electronic unit 42. At this operating mode there is always only one piezo element 20 of the piezo motor 12 excited, so that an overlapping of two vibration excitations of both piezo actuators 18 cannot occur.

According to the invention the piezoelectric drive unit is operated in its resonance frequency 44. The electronic unit 42 provides therefore a tuning circuit 46, which controls the corresponding piezo element 20 in such a way that the entire system vibrates in resonance. The electronic unit 42 can for example be arranged at least partially also within the actuator housing 22 or the bearing 36. FIG. 1 shows the amplitude 45 of the resonance frequency 44 of the longitudinal vibration 26 in the two piezo actuators 18, whereby the two piezo actuators 18 are not exited simultaneously at this operating mode. The maximum amplitudes 45 correspond here with the mechanic resonance frequency 44.

FIG. 2 shows a variation of the drive unit 10, at which the piezo motor 12 is stored in a body panel 17. Whereas the friction surface 14 is construed as circumferential surface of a rotational body 48, so that the rotational body 48 is put into rotation by the tappet movement of the friction element 30. According to the operating mode that is described in FIG. 1 the direction of rotation 49 of the rotational body 48 can be preset on the other hand by the controlling of only one piezo element 20 at one of the two piezo actuators 18. Such a drive unit 10 generates a rotation as driving movement and can therefore be used instead of an electromotor with a downstream transmission.

FIG. 3 shows an enlarged piezo element 20 as it can for example be used in the piezo motor 12 of FIG. 1 or 2. The piezo element 20 provides several layers 50, which are separated from each other and between which the electrodes 40 are arranged. If a voltage 43 is applied at the electrodes 40 by the electronic unit 42, the piezo element 20 extends in longitudinal direction 19. The expansion of the individual layers 50 adds up so that the mechanic total amplitude 45 of the piezo element 20 in longitudinal direction 19 can be preset by the number of layers 50. The layers are thereby arranged transversally to the longitudinal direction 19 in the actuator housing 22, so that the entire piezo actuator 18 is put into longitudinal vibration by the piezo element 20. The piezo element 20 is preferably made of a high-grade ceramic 21, so that very big amplitudes 45 can be generated in the resonance operation of the piezo element 20.

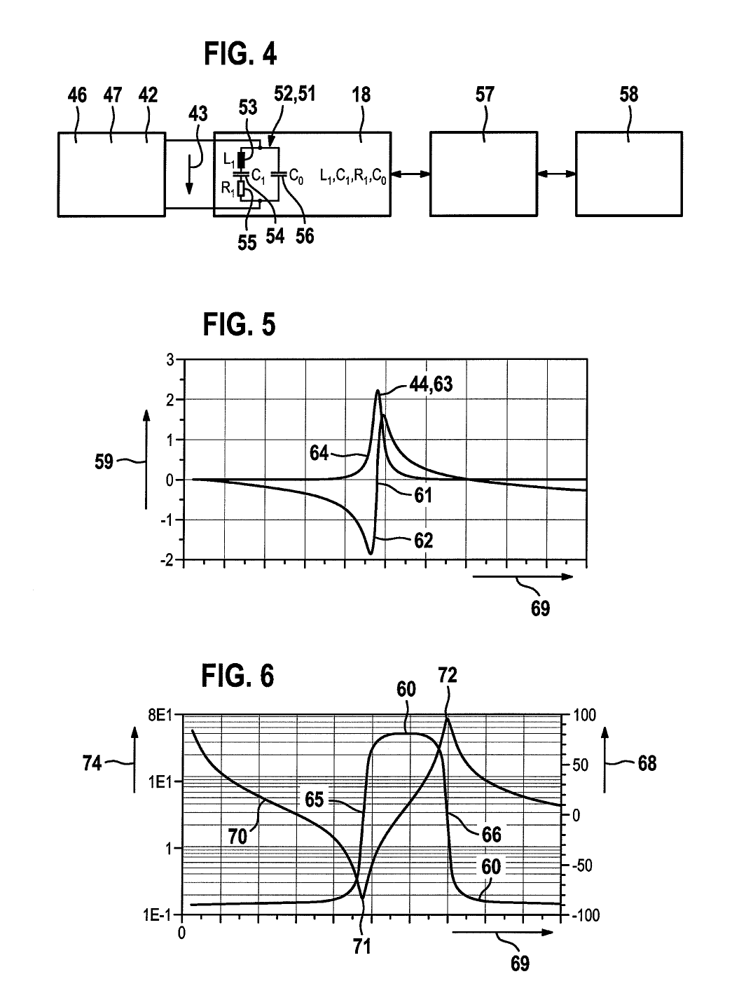

FIG. 4 shows a model of the piezoelectric drive unit 10 that serves as basis for adjusting the resonance frequency 44. The piezo actuator 18 is thereby illustrated as resonant circuit 52, in which an inductivity 53 is switched in series with a first capacity 54 and an ohmic load 55. A second capacity 56 is therefore switched parallel. An excitation voltage 43 is applied at this resonant circuit 52 by means of the electronic unit 42. The resonance frequency 44 of the piezo actuator 18 is influenced by the conversion of the longitudinal vibration 26 of the piezo actuator 18 into the tappet movement of the friction element 30. Furthermore the resonance frequency 44 of the entire drive unit 10 depends on the load 58, which is for example determined by the weight of the part 11 that has to be adjusted and/or the frictional condition between the friction element 30 and the friction surface 14.

According to this circuit diagram a frequency response adjust at the excitation of the adjusting device 10 by means of the electronic unit 42, as it is shown in FIG. 5. The power 59 is thereby put above the frequency 69. At the zero crossing 61 of the illustrated idle power 62 a maximum 63 of the effective power 64 occurs. The maximum 63 of the effective power 64 occurs at the resonance frequency 44, to which the piezoelectric drive unit 10 is adjusted by means of the tuning circuit 46. The resonance frequency 44 lies for example in the range between 30 and 80 kHz, preferably between 30 and 50 kHz.

FIG. 6 shows the corresponding impedance behavior of the piezo motor 12 over the frequency response. The phase advance 60 of the impedance of the adjusting unit 10 that is illustrated by the resonant circuit 52 according to FIG. 4 provides a first zero crossing 65 with a positive gradient and a second zero crossing 66 with a negative gradient, which correspond with the series and the parallel resonance of the resonant circuit 52. The phase angle 68 is illustrated on the ordinate on the right side of the diagram. In order to keep the drive unit 10 in resonance operation—for example also at a variable load 58—the tuning circuit 46 regulates the frequency 69 for example to the zero crossing 65 with a positive gradient, which can be electronically realized pretty simply by a phase regulator loop 47 (PLL: phase locked loop). The left abscissa 74 illustrates the amount 70 of the impedance, whereby the impedance course 70 over the frequency 69 provides a minimum 71 at the first zero crossing 65 and a maximum 72 at the second zero crossing 66.

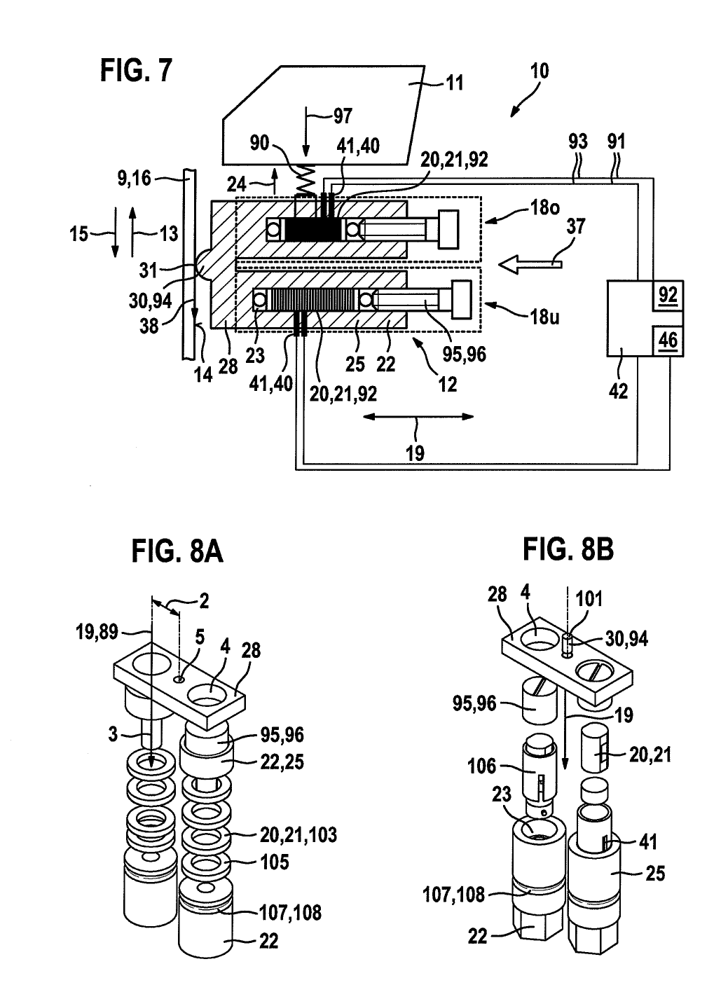

FIG. 7 shows a further example of a piezoelectric drive unit 10, at which the linear rail 16 is construed as vertical guide 9. Like in FIGS. 1 and 2 the piezo motor 12 provides two piezo actuators 18, which are arranged in longitudinal direction 19. The two piezo actuators 18 are connected with each other by a bridging web 28, whereby it is for example made in one piece with the actuator housings 22. A friction element 30 is again construed at the bridging web 28, which connects frictionally with its end 31 to the friction surface 14 of the linear rail 16. The friction element 30 is for example construed as arched tappet 94, which carries out a micro-stroke movement towards the rail 16. A piezo ceramic 21 is arranged as piezo element 20 on the inside of the two actuator housings 22, which provides a bigger expansion in longitudinal direction 19 than in transversal direction 24. The piezo elements 20 are mechanically pre-stressed in longitudinal direction 19 and this is why they are clamped within a hollow room 23 by clamping elements 95. The clamping elements 95 are for example construed as screws 96, which can be directly screwed into a thread of the actuator housing 22. The drive unit 10 is here construed as window pane drive, at which the piezo motor 12 is connected to the part 11, which has to be adjusted and which is here construed as pane. For performing the relative movement in a first moving direction 13 (lifting) only the lower piezo actuator 18u is controlled by means of the electronic unit 42 according to this embodiment. By exciting the lower piezo element 20 the friction element 30 performs a pushing movement or an elliptical movement 32, whereby the piezo motor 12 pushes itself along the first moving direction 13 with the aid of a tangential force component 38. Due to the mechanic hysteresis of the bridging web 28 that is arranged at the piezo actuator 18 the excited longitudinal vibration 26 is converted into an elliptical movement of the tappet 94, which deviates correspondingly from the system parameters of a pure linear movement. The piezo motor 12 is thereby pressed against the friction surface 14 in longitudinal direction 19 with a normal force 37.

No excitation signal 93 is applied at the upper piezo actuator 18o while the lower piezo actuator 18u is excited. Thereby either the lower piezo actuator 18u can be triggered consecutively to lift the part 11 or the upper piezo actuator 18o to lower the part 11 with only one single electronic unit 42, with only one single tuning circuit 46. Therefore there is no overlapping of several excitation signals 93, whereby the piezo motor 12 is always triggered in one phase. One identical excitation signal 93 can thereby be used for exciting the lower piezo actuator 18u and for exciting the upper piezo actuator 18o, which is generated by the tuning circuit 46 of the electronic unit 42.

FIGS. 8a and 8b shows each a piezo motor 12 in an exploded view, whereby two piezo actuators 18 are connected with each other by a bridging web 28. The piezo actuators 18 provide a bigger expansion in longitudinal direction 19 than in transversal direction 24 and are arranged basically parallel to each other. The bridging web 28 is arranged almost vertically to the longitudinal direction 19 and spreads out almost parallel to the corresponding friction surface 14, as it is shown in FIG. 1. In the embodiments of FIGS. 8a and 8b the bridging web 28 and the friction element 30 are each construed as separate component, which is then mounted together with the actuator housing 22. The bridging web 28 provides therefore recesses 4, into which the clamping elements 95 can be inserted for creating a pre-stressing for the piezo element 20. The piezo element 20 consists in FIG. 8a of a stack ceramic 103, at which several ceramic rings 105 are stacked on each other in longitudinal direction 19 and clamped against each other with the clamping element 95. The clamping element 95 is for example construed as screw 96, which can be screwed or inserted into the recess 4 on the one hand, and also screwed into the actuator housing 22 on the other hand. The actuator housing 22 is for example construed as cylindrical housing capsule 25, which provides in FIG. 8a the same external diameter as the stack ceramic 103. In FIG. 8b on the other hand the piezo element 20 is construed as multilayer ceramic 104, which provides a smaller external diameter than the actuator housing 22. The piezo element 20 is thereby electrically isolated from the actuator housing 22 by a isolating element 106. The actuator housing 22 provides for example an internal thread, into which the screw-shaped clamping elements 95 are screwed. The bridging web 28 provides a further recess 5, into which the friction element 30 is inserted. The friction element 30 is construed as tappet 94, which provides a bigger expansion in longitudinal direction 19 than in transversal direction 24. The tappet 94 provides an impact surface 101, which extends basically parallel to the bridging web 28 and parallel to the corresponding friction surface 14. The friction element 30 is arranged almost in the center between the two piezo actuators 18 and provides a distance 2 to the central axis 89 of the piezo actuators 18. For bearing the piezo actuators 18 with the aid of the bearing element 36 (see FIG. 1) a slot 107 is formed at the actuator housing 22, which is for example construed as a circumferential slot 108. The slot 107 is preferably arranged in the area of the vibration node 34 of the piezo actuator 18. As an alternative to the cylindrical construction of the actuator hosing 22 it can also provide a square profile, as it is for example shown in FIGS. 1 and 2.

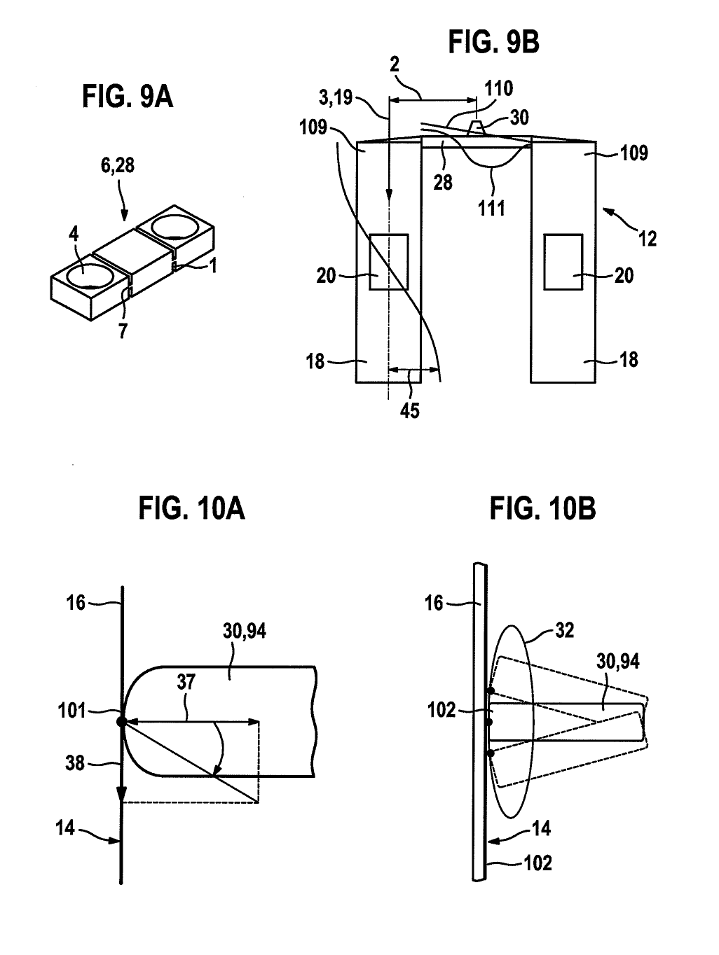

FIG. 9a shows an alternative embodiment of the bridging web 28, whereby said is construed as plate 6 or beam that is flexibly connected to the piezo actuator 18 and that is stiff. In order to enable a slight tilting of the bridging web 28, the plate 6 provides areas 7 with a reduced material profile. Those areas 7 are quasi construed as flexible areas, which enable a snapping off of the plate 6. Slots 1 are therefore formed into the bridging web 28—in particular over the entire width of the bridging web 28—whose number and depth determine the mobility of the bridging web 28. An alternative embodiment of the bridging web 28 can be construed by a continuous change of the material profile over the length of the bridging web 28, or as plate that can be easily bended, whereby materials are used that correspondingly bend easily. Between the flexible areas a material can be arranged that is either stiff or that bends easily.

FIG. 9b schematically shows different vibration types of the piezo motor 12, which is determined by a corresponding determination of the bending stiffness of the bridging web 28 or the actuator housing 22 and its assembly. If for example only one piezo actuator 18 (left) is put into longitudinal vibration 26 with the aid of the piezo element 20, the upper end 109 of the piezo actuator 18 moves in longitudinal direction 19 with a corresponding amplitude 45. The second not excited piezo actuator 18 (right) works together with the bridging web 28 as passive mass, which is only excited by the first piezo actuator 18. If the bridging web 28 is connected flexibly and construed relative stiff it carries out a vibration in longitudinal direction 19 on the left side, which is stronger than on the right side of the bridging web 28. This is schematically illustrated by the indicated mechanic vibration amplitude 110 of the bridging web 28. The friction element 30 vibrates thereby also primary in longitudinal direction 19. But the moving components of the friction element 30 and the bridging web 28 do also depend on the adjustment of the resonance frequencies of the two piezo actuators 18, so that a moving component can also be generated in transversal direction 24 by a targeted alienation of the entire system. Such a vibration type of the friction element 30 is called “tilting beam”. If on the other hand both piezo actuators 18 at a flexibly connected, stiff bridging web 28 are simultaneously excited with a phase drift (two-phased), for example by 90°, this causes a tilting of the bridging web 28 around its central point, so that the friction element 30 carries out a so-called “shaking beam” vibration. The amount and the direction of the relative movement at the friction element 30 and the friction surface 14 can thereby be controlled by adjusting the phase drift.

If on the other hand a soft bridging web 28 is used, for example a plate 6 that can be bended easily, a so-called “la ola” vibration of the friction element 30 can be achieved by exciting a piezo actuator 18 in longitudinal vibration 26. Due to the transmission of the bending and longitudinal vibration 26 an elliptical movement of the friction element 30 occurs. The bending movement of the bridging web 28 can thereby be tuned resonantly, but this is not mandatory. The la ola vibration is illustrated in FIG. 9b by the amplitude curve 111 of the mechanic vibrations of the bridging web 28.

The stiffness of the bridging web 28 with the actuator housing 22 is not necessarily the same as the stiffness of the piezo element 20. Therefore both parts can have two different response times related to their own vibration, so that there is a risk at a too low pre-stress force, that the piezo element 20 contracts itself faster than the actuator housing 22. A too high pre-stress force on the other hand would reduce he vibration amplitude in the quasi-statistic area too much. Therefore the pre-stress force is adjusted in such a way that no pulling forces occur in the piezo element 20 in an excited state but vibration amplitudes 45 can be achieved in the resonance mode that are as high as possible. The clamping elements 95 serve also for conducting away the heat that is generated in the piezo element 20 and are therefore made of a material with good heat conductivity.

FIGS. 10a and 10b schematically illustrate again how a relative movement towards the friction surface 14 is generated by moving the friction element 30. The friction element provides for example an arched impact surface 101, which is however basically construed parallel to the friction surface 14 in the area of the contacting of the friction surface 14. The contacting can thereby be construed as dot- or linear-shaped contact surface. The friction element 30 is pressed with a normal force 37 against the friction surface 14. The normal force 37 is overlapped with the pushing or elliptical movement 32 of the friction element 30. A tangential force component 38 occurs thereby, which causes a relative movement according to the directions 13 or 15 due to the friction. The friction element 30 can therefore provide either a special coating 102, which increases the friction value, and reduces the wear of the moved part. Or the friction surface 14 can also provide a special coating 102 or surface condition in order to improve the friction pairing between the friction surface 14 and the friction element 30. The elliptical movement 32 of the friction element 30, which is converted into a linear relative movement 13, 15 due to the friction pairing between the friction element 30 and the friction surface 14, is for example symbolically illustrated in FIG. 10b.

With regard to the figures and the embodiments that are shown in the description, it shall be noted that various combinations of the individual characteristics are possible. The concrete configuration of the piezo actuators 18, their actuator housing 22, the piezo elements 20 (mono-bloc, stack- or multilayer), the bridging web 28 and the friction element 30 can thus for example be varied according to the application. The tappet movement can thereby be construed as pure pushing movement or basically as elliptical or circular moving track, whereby the friction pairing between the friction element 30 and the friction surface 14 provides a higher or lower friction value according to the transversal component of the force transmission. The linear tappet movement establishes thereby the boarder case of the elliptical movement. A configuration with a pure form fit is also possible as boarder case, at which the friction element 30 grips into a corresponding recess, for example into a micro toothing of the drive element, for example the linear guide rail 16 or the rotational body 48. The angle between the piezo actuators 18 can deviate in an alternative embodiment also from approximately 0° and amount up to 100°. The longitudinal direction of the tappet 94 can also be set in an angle range from 40° to 90° to the bridging web 28, whereby even the impact surface 101 of the tappet 94 can create an angle to the friction surface 14 and/or to the bridging web 28. In a further variation the piezo actuator 18 can be operated also with a bending vibration, which for example overlaps with the longitudinal vibration 26. The corresponding vibrations of several piezo actuators of one piezo motor 12 can also be excited simultaneously in one or several phases, whereby an overlapping of those vibrations causes a tappet movement, which puts the drive element into motion. According to the invention the drive unit 10 is preferably used for adjusting movable parts 11 in a motor vehicle, but is not limited to such an application.

1. Piezoelectric drive unit for adjusting movable parts, especially in a minor vehicle, with at least one piezo motor that provides at least one piezo actuator, whereby a relative movement in relation to a frictional surface located across from the frictional element can be generated with the aid of at least one frictional element of the piezo motor wherein the at least one frictional element is disposed on a bridging web of the motor, which places the frictional element at a distance from the central axis of the at least one piezo actuator, said central axis extending in a longitudinal direction.

2. Piezoelectric drive unit according to claim 1 wherein the bridging web extends almost vertically towards the longitudinal direction and in that the friction element extends almost in longitudinal direction.

3. Piezoelectric drive unit according to claim 1 wherein the at least one friction element provides an impact surface which works together with the friction surface for the transmission of a driving force, whereby the impact surface is basically oriented vertically towards the longitudinal direction in particular in idle mode of the piezo motor.

4. Piezoelectric drive unit according to claim 1, wherein two piezo actuators are arranged almost parallel to each other in relation to their longitudinal direction with a distance to each other and are connected with each other with the aid of the bridge web.

5. Piezoelectric drive unit according to claim 1, wherein the friction element is attached at the bridge web as plunger-type extension in longitudinal direction, preferably approximately in the middle between the two piezo actuators.

6. Piezoelectric drive unit according to claim 1, wherein the impact surface is construed curved, and in that it provides in particular a surface with an increases friction value.

7. Piezoelectric drive unit according to claim 1, wherein the bridge web is construed as separately manufactured, flat plate, on which the separately manufactured friction element can be attached.

8. Piezoelectric drive unit according to claim 1, wherein the at least one piezo actuator provides a housing capsule, in whose hollow the piezo element is arranged electrically isolated against the housing capsule.

9. Piezoelectric drive unit according to claim 1, wherein the bridge web is construed in one piece with the housing capsule of the at least one piezo actuator and in particular in one piece with the friction element.

10. Piezoelectric drive unit according to previous claims is thereby characterized, in that claim 1, wherein the piezo element, which is in particular construed as multilayer ceramic or stack ceramic, is pre-stressed in the actuator housing with the aid of span elements.

11. Piezoelectric drive unit according to claim 1, wherein the bridge web provides a recess—in particular with a thread, into which the span element—in particular a screw—reaches in longitudinal direction.

12. Piezoelectric drive unit according to claim 1, wherein the bridge web is construed as a soft plate, which bends easily and which in particular provides areas with a reduced material thickness.

13. Piezoelectric drive unit according to claim 1, wherein the bridge web is construed as a plate, which is flexibly connected with at least one of the piezo actuators and whose areas between the flexible connections can either be construed stiff or bended easily.

14. Piezoelectric drive unit according to claim 1, wherein the friction element carries out a pure pushing movement or an elliptical track movement depending on the bending stiffness of the bridge web.

15. Piezoelectric drive unit according to previous claims is thereby characterized, in that claim 1, wherein the friction element pushes itself off at the friction surface with the aid of friction lock and/or form fit—in particular with the aid of a form-fitted micro structure.

16. Piezoelectric drive unit according to claim 1, wherein the piezo motor is arranged at the movable part, and the friction surface is construed stationary, or in that the piezo motor is arranged stationary and the friction surface is arranged at the movable part.

17. Piezoelectric drive unit according to claim 1, wherein the piezo element provides electrodes, which provide a contact element at the actuator housing with which the piezo element can be connected to a electronic unit for controlling the piezo ceramic.

18. Piezoelectric drive unit according to claim 1, wherein the at least one piezo actuator can be excited in longitudinal vibration—in particular exclusively in longitudinal direction without transversal components, and in that the at least one piezo actuator is stored in a vibration node and pushed against the friction surface with a normal force.

19. Piezoelectric drive unit according to claim 1, wherein the piezo motor provides exactly two piezo actuators, whereby only one piezo actuator is operated for a first movement direction of the relative movement and the other piezo actuator is operated for the opposite movement direction—preferably each in resonance operation.

20. Procedure for operating a piezoelectric drive unit according to claim 1, wherein the piezo motor is operated in the area of its resonance frequency.

21. Procedure for operating a piezoelectric drive unit according to claim 1, wherein two piezo actuators of a piezo motor are connected with each other with the aid of a bridge web that bends easily and in that the two piezo actuators have significantly different resonance frequencies, so that when exciting only one of the two piezo actuators the other piezo actuator acts as a fixed clamping of the bridge web.

22. Procedure for operating a piezoelectric drive unit according to claim 1, wherein only one of the two piezo actuators is excited per movement direction in particular exclusively in longitudinal direction, and in that a bending shaft occurs in the bridge web, whereby the bending movement does not have to be resonant.

23. Procedure for operating a piezoelectric drive unit according to claim 1, wherein two piezo actuators of a piezo motor are connected with each other with the aid of a stiff bridge web and in that both piezo actuators provide resonance frequencies that differ from each other, so that when exciting only one of the two piezo actuators the bridge web carries out an elliptical movement with the friction element.

24. Procedure for operating a piezoelectric drive unit according to claim 1, wherein the approximately identical resonance frequencies are slightly alienated against each other, so that the pushing movement provides an additional movement component in transversal direction.
